(19) United States
(12) Patent Application Publication
(10) Pub. No.: US 2015/0342372 A1
(43) Pub. Date: Dec. 3, 2015

(54) MAGNETIC MULTI-DIRECTIONALLY ADJUSTABLE PICTURE FRAME MOUNT AND FRAME MOUNTING METHOD

(71) Applicant: Justin Marshall Chafe, Minneapolis, MN (US)

(72) Inventor: Justin Marshall Chafe, Minneapolis, MN (US)

(21) Appl. No.: 14/294,111

(22) Filed: Jun. 2, 2014

(51) Int. Cl. A47G 1/06; G09F 7/04

(52) U.S. Cl. CPC A47G 1/06; G09F 7/04; A47G 2001/0672

(57) ABSTRACT

A magnetic mounting device secures a picture frame to a wall that allows adjustment up, down, left or right without removing the frame from the wall or using tools. The magnetic mounting device includes magnets to secure the picture frame to the mounting plate that is adhered to the wall. The picture frame may include one or more magnetic mounting device assemblies depending on the weight of the frame and the degree of desired wall adhesion.

### FIELD

The present invention relates to frames for pictures and artwork, and more particularly to the method of hanging/mounting picture frames on walls or other non-ferrous surfaces, which comprise a multi-piece magnetic system to mount and adjust the frame when it is hung/mounted.

### BACKGROUND

There have been numerous attempts to improve picture frames. For example, U.S. Pat. No. 6,354,030 B1 discloses a magnetic picture frame for use in hanging a picture on a refrigerator. This example uses magnets as a picture frame to secure pictures to a refrigerator. While it uses magnetic force to secure the frame, its use is limited to ferrous surfaces and is not based on a complete magnetic mounting device system.

U.S. Pat. No. 7,762,517 B1 discloses an adjustable picture frame that includes a mounting base that is secured to the wall using screws or other similar fasteners. There are movable inner and outer carriages on the bracket allowing the frame to be positioned on the wall through up/down and left/right directional adjustments. While this device allows for small adjustments like the magnetic multi-directionally adjustable picture frame, the attachment mechanism is different, the adjustment mechanism is different and it requires the user to use screws to secure the apparatus to the wall.

U.S. Pat. No. 3,1187,449 “Magnetic Picture Frame and Sign” discloses a picture frame with magnets used to affix the frame to an automobile dashboard. While it uses magnetic force to secure the frame, its use is limited to ferrous surfaces and is not based on a complete magnetic mounting device system.

U.S. Pat. No. 4,785,562 “Magnetic Display Holder” discloses an adjustable display device (frame) that secures and displays items of various sizes to ferrous surfaces. While it uses magnetic force to secure the frame, its use is limited to ferrous surfaces and is not based on a complete magnetic mounting device system.

U.S. Pat. No. US 2012/0233898 A1—“Adjustable Framed Picture Hanger Back” discloses a device for hanging a framed picture that allows for vertical and or horizontal adjustment on the wall as well as rotation of the framed picture. The mechanism for affixing the frame to the wall, and its subsequent adjustment is significantly different from the Magnetic multi-directionally adjustable picture frame mount and associated magnetic mounting method; specifically it does not use magnetic force and uses a different friction based attachment mechanism.

Accordingly, there is a continuing need to provide an improved picture frame mounting and adjustment mechanism and method.

### SUMMARY

An objective of the invention is to provide a mounting device system which allows a picture frame to be quickly hung or mounted to a wall or non-ferrous mounting surface, leveled, adjusted and or aligned without removing the frame from the wall, or putting holes in a wall or other mounting surface.

A magnetic mounting device system according to certain embodiment of the invention secures a picture frame to a wall that allows adjustment up, down, left or right without removing the frame or mounting device system from the wall and does not require tools to make wall position adjustments within the limited range of the mounting plated. The magnetic mounting device includes magnets that are secured to the picture frame through a mounting bracket, adhesive or combination of mounting bracket and adhesive, using magnetic force the frame is then connected to the ferrous mounting plate that is adhered to the wall. After the frame is mounted to the wall or mounting surface, the frame can be adjusted in any direction provided the magnets maintain contact with the mounting plate; the adjustment range is limited by the size of the mounting plate. The picture frame may include one or more magnetic mounting device assemblies depending on the size and weight of the frame and the degree of desired wall adhesion.

In certain embodiments, the steel or magnetic mounting base or bases are attached to the wall using an adhesive agent (e.g. double sided tape, glue or adhesive strip, such as 3M COMMAND brand adhesive strips). The magnet or magnets can be attached to the picture frame assembly using an adhesive, mounting bracket or mechanical fastener.

The above summary is not intended to limit the scope of the invention, or describe each embodiment, aspect, implementation, feature or advantage of the invention. The detailed technology and preferred embodiments for the subject invention are described in the following paragraphs accompanying the appended drawings for people skilled in this field to well appreciate the features of the claimed invention. It is understood that the features mentioned hereinbefore and those to be commented on hereinafter may be used not only in the specified combinations, but also in other combinations or in isolation, without departing from the scope of the present invention.

### BRIEF DESCRIPTION OF THE DRAWINGS

FIG. 1 is a side exploded view of a magnetic picture frame mounting system device according to certain embodiments of the invention.

FIG. 2 is a side view of a magnetic picture frame mounting system device according to certain embodiments of the invention attached to a wall.

FIG. 3 is a rear view of a magnetic picture frame mounting system device according to certain embodiments of the invention.

FIG. 4 is a front view of a magnetic picture frame mounting system according to certain embodiments of the invention indicating possible directions of movement.

FIG. 5 is a side view of a magnetic picture frame mounting system according to certain embodiments of the invention indicating possible directions of movement.

FIG. 6 is a perspective view of a magnetic picture frame mounting system according to certain embodiments of the invention.

FIG. 7 is a perspective view of a magnetic picture frame mounting system according to certain embodiments of the invention.

While the invention is amenable to various modifications and alternative forms, specifics thereof have been shown by way of example in the drawings and will be described in detail. It should be understood, however, that the intention is not to limit the invention to the particular example embodiments described. On the contrary, the invention is to cover all modifications, equivalents, and alternatives falling within the scope of the invention as defined by the appended claims.

### DETAILED DESCRIPTION

In the following descriptions, the present invention will be explained with reference to various example embodiments; nevertheless, these embodiments are not intended to limit the present invention to any specific example, environment, application, or particular implementation described herein. Therefore, descriptions of these example embodiments are only provided for purpose of illustration rather than to limit the present invention. The various features or aspects discussed herein can also be combined in additional combinations and embodiments, whether or not explicitly discussed herein, without departing from the scope of the invention,

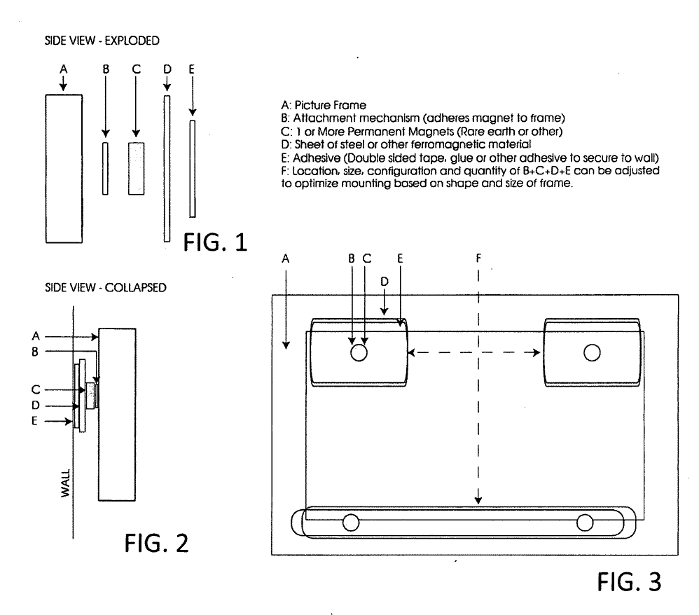

Referring to FIGS. 1-3, the various components of the system according to one embodiment are depicted. The number and location of the mounting assemblies on a given frame will vary based on picture frame size, shape and weight.

As can be seen in FIG. 1, the mounting assembly depicted comprises picture frame (A), magnet attachment mechanism (B), permanent magnet(s) (C), steel sheet metal or other ferromagnetic material (D) and wall adhesive (E) as assembled onto the back of a picture frame in the order listed.

FIG. 2 shows the components noted above as they would be arranged when in use for securing the picture frame to a wall. The wall adhesive (E) is attached directly to the wall or surface securing the sheet of steel or other ferromagnetic material (D) to the wall. The permanent magnet(s) (C) connect the picture frame to the steel magnetically and allow the picture frame to be easily removed and reattached to the sheet of steel mounting plate (D). The magnets (C) are attached to the rear of the picture frame by adhesive or mechanical means, such as a fastener.

FIG. 3 illustrates of some of the many potential locations for providing the magnetic mounting assemblies to a picture frame. In the illustrated example embodiment, there is one assembly at each of the top left and right corners, and one assembly spanning horizontally along the bottom region of the frame. This arrangement balances out the weight of the frame as indicated by line (F). Of course, the number, size and locations of the magnetic mounting assemblies can be varied depending on the weight of the frame, size of the frame and strength of desired wall adhesion.

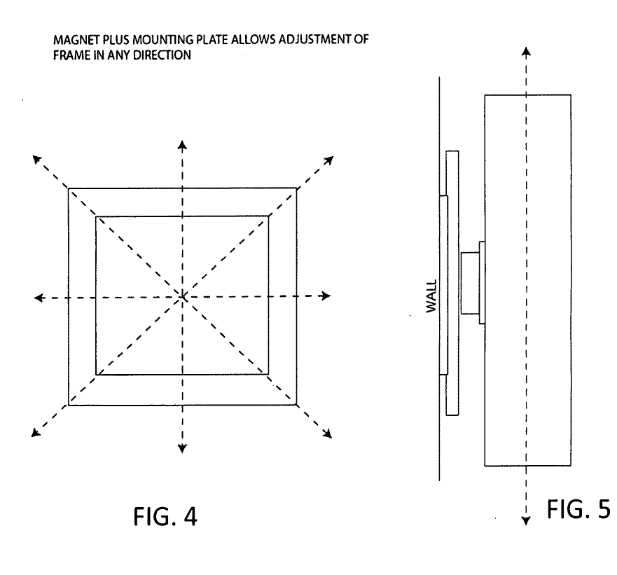

The magnets are permanently secured to the rear of the picture frame when in use and do not move. With the magnets secured to the frame, the frame can be easily re-positioned anywhere on the surface of the steel plate that is affixed to the wall, while maintaining secured to the wall. Thus, the user can easily adjust the picture frame left to right, up and down, diagonally, etc. in the two-dimensional plane of the wall to achieve a user's desired placement and rotational orientation of the picture frame. The arrows provided to FIGS. 4-5 illustrate examples of the possible adjustment of the picture frame permitted by the present invention.

The frame can also easily be leveled by moving one of the right or left sides upward or downward with respect to the other.

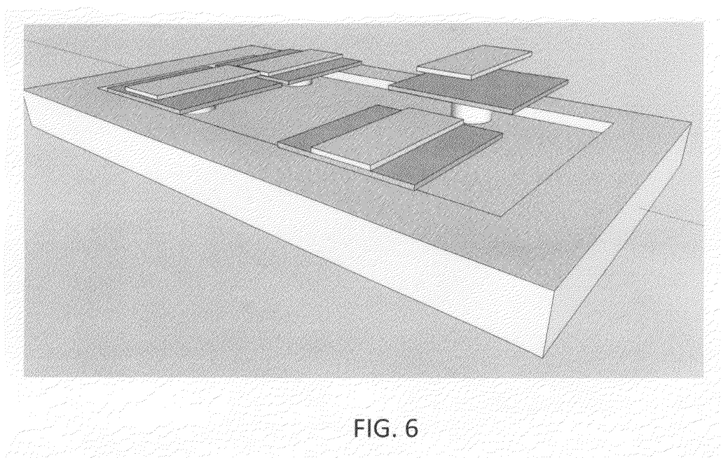

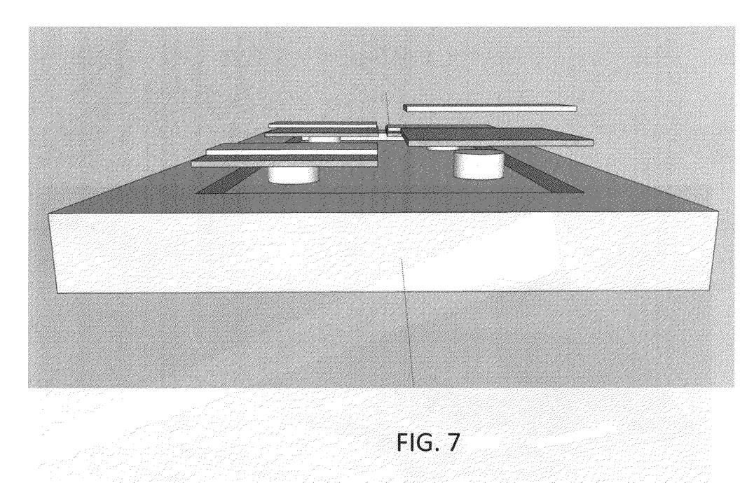

FIGS. 6-7 show additional embodiments of the invention. Here, there are four separate magnet assemblies, one adjacent each corner of the frame. The assemblies are set inward from the outer edges of the frame so that the steel plates are not visible when the frame is secured to the wall.

Note that in both of FIGS. 6-7, one of the magnet assemblies is shown with its components in an exploded depiction to aid in understanding the invention.

In use, the magnets are secured to the rear of the picture frame. Then the steel plates are disposed on the magnets, preferably so that the magnets are approximately centered on the respective plates. The wall adhesive is applied to the wall-facing side of the steel plates either before or after disposing the plates on the magnets. If necessary, the wall adhesive is exposed. Then the frame is pressed against the wall or other surface in a desired location. The adhesive is permitted to set, if necessary. Then the user can slide the magnets along their respective plates to reposition and orient the frame as desired by applying force to the edges of the frame. Pulling the frame in a direction normal to the wall severs the magnetic securement from the steel plates fastened to the wall.

The “wall” as described herein is not limited to merely a wall. The “wall” can be any generally flat surface or other surface conforming to the contour of the frame.

While the invention has been described in connection with what is presently considered to be the most practical and preferred example embodiments, it will be apparent to those of ordinary skill in the art that the invention is not to be limited to the disclosed example embodiments. It will be readily apparent to those of ordinary skill in the art that many modifications and equivalent arrangements can be made thereof without departing from the spirit and scope of the present disclosure, such scope to be accorded the broadest interpretation of the appended claims so as to encompass all equivalent structures and products.

For purposes of interpreting the claims for the present invention, it is expressly intended that the provisions of Section 112, sixth paragraph of 35 U.S.C. are not to be invoked unless the specific terms “means for” or “step for” are recited in a claim.

What is claimed is:

1. A picture frame mounting system as disclosed herein.

2. A magnetic mounting assembly for a picture frame as disclosed herein.

3. A method of mounting a picture frame to a wall as disclosed herein.

4. The device as disclosed herein.

5. The system as disclosed herein.

6. The method as disclosed herein.
